(19) United States
(12) Patent Application Publication
(10) Pub. No.: US 2004/0126313 A1
(43) Pub. Date: Jul. 1, 2004

(54) Methods and processes of hydrogen peroxide production

(76) Inventor: Richard A. Haase, (US)

Correspondence Address: Richard H. Haase, 4402 Ringrase Dr., Missouri City, TX, 77459, US

(21) Appl. No.: 10/602,742

(22) Filed: Jun. 24, 2003

Related U.S. Application Data
(60) Provisional application No. 60/390,976, filed on Jun. 24, 2002.

(51) Int. Cl. C01B 15/03

(52) U.S. Cl. 423/585

(57) ABSTRACT

The present invention relates to simplified processes for the preparation of pure hydrogen peroxide (H₂O₂). H₂O₂ is a known oxidizer and disinfectant that is used in many industrial processes having many uses in the pharmaceutical, electronic, food and water purification industries. The present invention presents the use of sulfuric acid (H₂SO₄) as a catalyst utilizing water and electricity as the only raw materials for the production of H₂O₂. Separation processes are performed with membranes. Produced hydrogen is used as a fuel in a fuel cell, thereby reducing electrical cost.

H₂O₂ is an ideal oxidizer and disinfectant in water purification systems, especially drinking water purification. All other disinfectants create disinfection by-products upon their reaction with Natural Organic Matter (NOM) in the water. Pure H₂O₂ is a requirement for the electronics industry in the production of printed circuit boards. By producing H₂O₂ without organic chemistry, organic contamination of H₂O₂ is minimized.

### RELATED APPLICATION DATA

This application claims priority based on a provisional application, U.S. 60/390,976.

### FIELD OF THE INVENTION

The present invention relates to simplified processes for the preparation of hydrogen peroxide (H₂O₂). H₂O₂ is a known oxidizer and disinfectant that is used in many industrial processes having many uses in the pharmaceutical, electronic, food and water purification industries.

The present invention presents the use of sulfuric acid (H₂SO₄) as a catalyst utilizing water and electricity as the only raw materials for the production of H₂O₂. H₂O₂ is an ideal oxidizer and disinfectant in water purification systems, especially drinking water purification. All other disinfectants create disinfection by-products upon their reaction with Natural Organic Matter (NOM) in the water. Many disinfection by-products currently produced from chlorine, chlorine dioxide and ozone are known toxins, carcinogens and teratogens in drinking water. In contrast, other than the oxidized organic molecule, H₂O₂ after reaction breaks down to water (H₂O) and Oxygen (O₂).

Current H₂O₂ manufacturing processes utilize the Anthraquinone Process (AP) to produce hydrogen peroxide from 2-ethyl anthraquinone. This is a two stage process; wherein the first stage 2-ethyl anthraquinone reacts with Hydrogen (H₂) over a lead catalyst to produce 2-ethyl dihydroanthraquinone and in the second stage, the 2-ethyl dihydroanthraquinone from the first stage, reacts with O₂ to produce H₂O₂ and 2-ethyl anthraquinone for recycle. This process requires the handling of two explosive chemicals, H₂ and O₂, as well as the handling of hazardous anthraquione chemistries. AP requires an industrial manufacturing environment for the production of H₂O₂ due to the safety issues associated with: the chemicals, the manufacturing process and the handling/transportation of H₂O₂.

### BACKGROUND OF THE INVENTION AND DESCRIPTION OF THE PRIOR ART

In the nineteenth century, H₂O₂ was produced exclusively on a commercial scale by the reaction of an acid upon barium peroxide, which is readily formed by heating barium oxide in air. The barium peroxide was then usually reacted with sulfuric acid to produce H₂O₂ along with a solid precipitate of barium sulfate. H₂O₂ is normally produced in the laboratory by the reaction of sodium peroxide with water or dilute hydrochloric acid. In this reaction, sodium oxide reacts with either H₂O or hydrochloric acid to form H₂O₂ along with either sodium hydroxide in the case of H₂O or sodium chloride in the case of hydrochloric acid.

Until the mid 20'th century, H₂O₂ was produced by the electrolysis of H₂SO₄, the Sulfuric Acid Process (SAP). SAP is a two stage process wherein the first stage H₂SO₄ is electrochemically converted to H₂S₂O₈ and H₂. In the second stage, the H₂S₂O₈ from the first stage is reacted with H₂O to form H₂O₂ and H₂SO₄ for recycle. At that time, this process was not as economical or as safe to operate as AP. At that time, SAP required the energy of electrolysis along with two stages of distillation, wherein the first stage of distillation required the separation of an explosive chemical, H₂, and the second stage of distillation required the separation of H₂O₂ from very corrosive H₂SO₄. AP replaced SAP due to both economical and safety issues.

However, AP presents other issues, the first of which is safety. H₂O₂ is a very hazardous chemical to store and to transport. Once produced, H₂O₂ requires specialized equipment in storage and in transportation. H₂O₂ at concentrations of over 20% can react violently with organic materials and with acids. H₂O₂ in concentrations of over 50% can explosively decompose or react with any electron acceptor material, such as acids, or organic materials. Another issue in relation to the AP production of H₂O₂ is purity. The AP process is rather complex. The steps in this process to produce high grade H₂O₂ include: hydrogenation, oxidation, extraction, solvent scrubbing, settling, cation resin treatment, carbon treatment, cation resin treatment, distillation, absorption and dilution. The product after the initial cation resin treatment is very pure except for the presence of organic contaminants, which are one of the key quality parameters for electronics grade peroxide, namely, total carbon.

Perhaps the single problem most experienced in the electronics industry is contamination during the manufacture of microcircuit devices, such as chips and wafers. As these devices become more complex and smaller in dimension, sensitivity to contamination becomes more acute. Contamination is a problem because contaminants, in the form of solid particles, can open or short a circuit, affect photolithographic reproduction, alter electrical properties and even damage the crystal structure of modern electronic devices.

In addition to the electronics industry, there are many uses for H₂O₂ in the water purification industry. Oxidation and disinfection processes with H₂O₂ produce much purer water than that with other oxidizers. Chlorine, chlorine dioxide, ozone, chloramines and bromine all produce by-products of disinfection that are either: toxic, carcinogenic or teratogenic. As such, these by-products are health issues to humanity, plant and animal life. In contrast, the products of oxidation with H₂O₂ are usually limited to oxygen (O₂), carbon dioxide (CO₂) and H₂O, along with the organic oxidation product. However, most water purification facilities are not interested in the storage and handling of H₂O₂ due to the safety issues associated with H₂O₂.

This instant invention proposes end-use on-site production of H₂O₂ utilizing a newly found SAP process instead of AP. This instant invention presents an improvement upon historic SAP by performing separation with membranes instead of by distillation. The utilization of membranes, either inorganic or organic or a combination thereof, would provide the ability of on-site production of H₂O₂, thereby eliminating the need for AP, as well as the transportation, storage and handling of H₂O₂.

Membrane technologies have been available since the early 1990's. Early versions of this technology were of organic form only. As of late, inorganic materials as known in the art have been incorporated in many applications. As of late, membrane technologies have been improved to incorporate electrolysis directly onto the membrane. This is accomplished by various methods known in the art, which make the membrane conductive; this conductivity can be accomplished in both inorganic and organic membranes.

In fuel cells, U.S. Pat. No. 4,490,445 teaches a solid oxide electrochemical energy converter comprising alternating layers of solid oxide electrolyte plates and electrical conductor plates. Each electrolyte plate includes a coating of a porous oxidizer electrode on a first surface of the electrolyte and a coating of a porous fuel electrode on a second surface of the electrolyte. Each conductor plate includes grooved networks formed by ridges which define gas passages on both surfaces of the conductor plate, such ridges being in electrical contact with electrode coatings on next adjacent electrolytes. Each conductor plate also possesses a means for tapping electricity from or introducing electricity into the converter. The conductor plates also possess circumferential ridges arranged along the edges of the conductor plate to define gas seals, the ridges being in contact with surface coatings on next adjacent electrolyte plates in which surface coatings possess the same composition as that of the electrode coatings.

U.S. Pat. No. 4,791,079 discloses two-layer conducting catalytic ceramic membranes which are suitable for use in a variety of hydrocarbon conversion reactions. The two-layer membrane possesses one layer formed of an impervious mixed ion and electronic conducting ceramic such as yttria stabilized zirconia which is doped with sufficient CeO₂ or TiO₂ to impart electron conducting characteristics to the ceramic. A second layer associated with mixed conducting impervious ceramic is a porous ion conducting layer containing a selective hydrocarbon oxidation catalyst.

A variety of methods have been presented for the separation of oxygen form air. A solid electrolyte oxygen pump formed from a plurality of solid-state membranes is presented in U.S. Pat. No. 4,877,506. The oxygen pump possesses electrodes which are shaped to form a plurality of linear, parallel channels on facing surfaces of the electrolyte. The air feed is introduced into the channels formed of the air electrode. Oxygen formed during operation of the device is removed by passage through the electrolyte via channels formed of the oxygen electrode or anode. A monolithic array is formed by situating an interconnecting material between adjacent cells to form a stack of cells. U.S. Pat. No. 5,034,023 discloses ceramic honeycomb structures which are capable of separating oxygen from an oxygen-containing gaseous mixture. The channeled honeycombs are formed from a solid electrolyte having at least some of the honeycomb channels sealed at one of its faces. The oxygen-containing gas is introduced into a first set of channels at one face of the honeycomb, a first voltage is applied to the interior walls of the channels and a second voltage is applied to the interior walls of the second set of remaining channels thereby creating an electrical potential across the ceramic material separating adjacent channels of the two sets. The electrical potential drives oxygen ions through the channel walls releasing molecular oxygen into the second set of channels which can be collected. U.S. Pat. No. 5,045,169 discloses an electrochemical device capable of generating oxygen from air upon the application of an electrical current, where a plurality of adjacent electrochemical cells are electrically connected in series, each cell containing an inner, porous oxygen electrode; a dense, solid oxide electrolyte capable of transporting oxygen ions partly disposed on top of the inner electrode and partly disposed between inner electrodes of adjacent cells; an outer porous air electrode disposed on top of the electrolyte; and separate, dense, electronically conductive segments of interconnection material disposed between adjacent cells, the interconnection electrically and physically connecting the outer air electrode from one cell to the inner oxygen electrode from an adjacent cell, the device having gas impermeable, dense, contacting segments of electrolyte and interconnection material between inner electrode of adjacent cells. U.S. Pat. No. 5,240,480 discloses representative solid-state membranes for separating oxygen from oxygen-containing gaseous mixtures. These membranes comprise a multi-component metallic oxide porous layer having an average pore radius of less than about 10 micrometers and a multi-component metallic oxide dense layer having no connected through porosity wherein the porous layers and dense layers are contiguous and such layers conduct electrons and oxygen ions at operating temperatures.

U.S. Pat. No. 5,356,728 and European Patent Application WO 94/24065 disclose cross-flow electrochemical reactor cells formed from multicomponent metallic oxides of the perovskite structure which demonstrate electron conductivity and oxygen ion conductivity at elevated temperatures. Such cells are useful in carrying out partial oxidation reactions of organic compounds to form added-value products and separating oxygen from oxygen-containing gaseous mixtures. The cross-flow reactor cells of U.S. Pat. No. 5,356,728 comprise either a hollow ceramic blade positioned across a gas stream flow containing one or more channels for flow of gas streams or a stack of crossed hollow ceramic blades containing one or more channels for flow of gas streams. Each channel has at least one channel wall disposed between a channel and a portion of an outer surface of the ceramic blade or a common wall with adjacent blades in a stack comprising a gas impervious multi-component metallic oxide, typically of a perovskite structure, which exhibits electron conductivity and oxygen ion conductivity at elevated temperatures. Thus, the channels are contiguous to the outer surface of the ceramic blade which is formed from the multi-component metallic oxide.

None of these patents teach or suggest electrolysis and membrane separation or electrolytic membrane separation as methods of H₂O₂ preparation.

In H₂O₂ manufacturing, membranes have been discussed as methods of H₂O₂ purification. U.S. Pat. Nos. 4,879,043 and 6,333,018 present the use of reverse osmosis membrane technology as a final purification step in the production of H₂O₂ manufactured by AP. U.S. Pat. Nos. 5,215,665; 5,262,058 and 5,906,738 present the use of reverse osmosis membrane technology in combination with cationic resin technology as final purification steps in the production of H₂O₂ manufactured by AP. U.S. Pat. Nos. 5,851,042 and 6,113,798 present the use of converting contaminant particles by reacting said particles with micro-ligands, then separating said reaction products with membranes as a final purification step in the production of H₂O₂ manufactured by AP. None of these patents teach or suggest electrolysis and membrane separation or electrolytic membrane separation as methods of H₂O₂ preparation.

U.S. Pat. No. 5,800,796 presents an electrochemical reactor wherein O₂ and H₂ are reacted across a conductive membrane containing reducing catalysts forming H₂O₂. This novel process eliminates AP while simplifying the process of H₂O₂ production. However, the potential for contamination of H₂O₂ with heavy metals from the reducing catalyst is significant. Heavy metals contamination eliminates the potential use of H₂O₂ in either the production of micro-circuitry or water purification. In addition, the potential safety issues from the reaction of very explosive O₂ and H₂ in an electrolytic environment preclude the potential use of this process at the end-use site.

All of these applications and many other industry applications of organic and inorganic membranes have shown the potentiality of membrane technologies. However, none of these applications or any other industrial application has proposed the use of membranes to improve the manufacturing process or the safety associated with and/or the handling of H₂O₂.

### SUMMARY OF THE INVENTION

A primary object of the invention is to devise an effective, efficient and economically feasible process for producing H₂O₂.

Another object of the invention is to devise an effective, efficient and economically feasible process for producing H₂O₂, wherein the safety in handling of H₂O₂ is improved.

Another object of the invention is to devise an effective, efficient and economically feasible process for producing H₂O₂, wherein transportation of H₂O₂ is not required.

Another object of the invention is to devise an effective, efficient and economically feasible process for producing H₂O₂, wherein significant storage of H₂O₂ is not required.

Another object of the invention is to devise an effective, efficient and economically feasible process for producing H₂O₂, wherein high purity H₂O₂ is manufactured.

Another object of the invention is to devise an effective, efficient and economically feasible process for producing H₂O₂, utilizing H₂SO₄ as a catalyst along with water and electricity as the raw materials.

Another object of the invention is to devise an effective, efficient and economically feasible process for handling H₂O₂ at water treatment plants so that H₂O₂ is an attractive alternate to other oxidizers and disinfectants utilized at water treatment plants.

Additional objects and advantages of the invention will be set forth in part in a detailed description which follows, and in part will be obvious from the description, or may be learned by practice of the invention.

### BRIEF DESCRIPTION OF THE DRAWINGS

FIG. 1 illustrates in block diagram form a general description of the proposed methods and processes of the instant invention wherein, H₂SO₄ is converted by electrolysis to H₂S₂O₈ and H₂ and wherein, said H₂S₂O₈ is reacted with H₂O to form H₂O₂ and H₂SO₄ and wherein, said H₂SO₄ from H₂S₂O₈ and H₂O is recycled for electrolysis into H₂S₂O₈ and H₂.

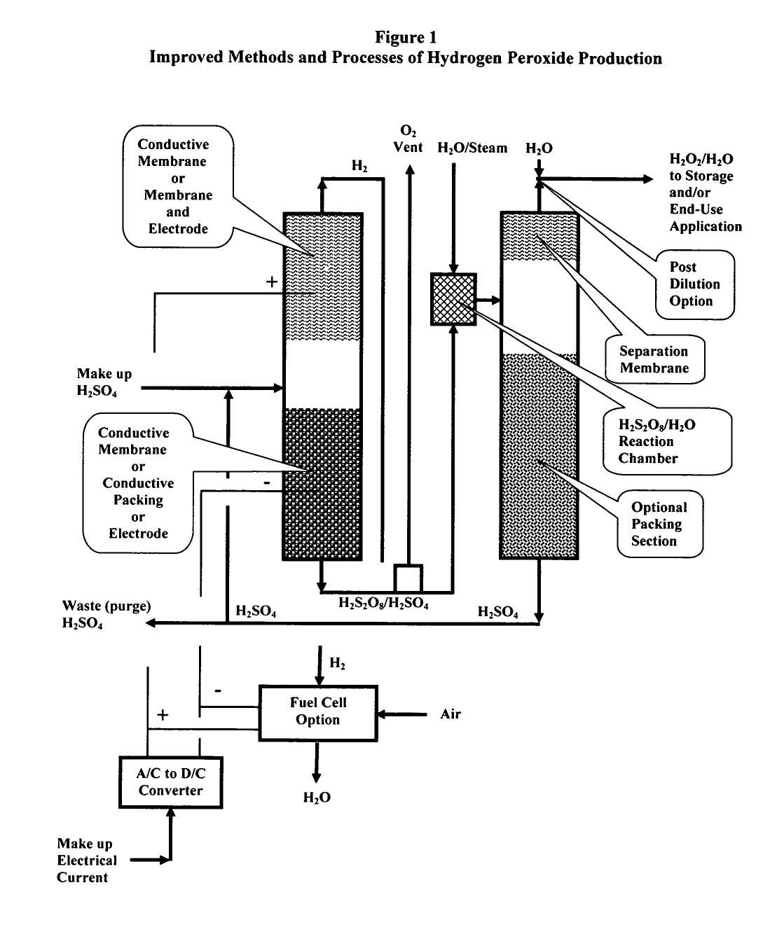

### DESCRIPTION OF THE PREFERRED EMBODIMENTS

The instant invention: improves the purity of H₂O₂, simplifies the manufacture of H₂O₂, eliminates the need to store large volumes of concentrated H₂O₂ and eliminates the need to transport H₂O₂. The instant invention presents the use of sulfuric acid (H₂SO₄) as a catalyst utilizing water (H₂O) and electricity as the only raw materials for the production of H₂O₂. The instant invention utilizes membrane technology in combination with electrolysis to produce H₂O₂ at the site of the end-user, whereupon H₂O₂ can be utilized with minimal storage and no transportation. The process of the instant invention, the New Sulfuric Acid Process (NESAP), is presented as a two stage process, wherein the first state H₂SO₄ is most preferably electrochemically converted to H₂S₂O₈ and H₂. The H₂ is separated and preferably used in a fuel cell to generate electricity. Said electricity for electrolysis is preferably at least partially used in the generation of H₂S₂O₈ and H₂ from H₂SO₄. In the second stage, the H₂S₂O₈ from the first stage is reacted with H₂O to form H₂O₂ and H₂SO₄. H₂SO₄ is preferably recycled to the first stage for electrochemical conversion, again, to H₂S₂O₈ and H₂. Since it can be rather cost ineffective to perform separations which are precise, separation in this invention is to be defined to mean substantial separation or separation of such percentage that the chemical process and the application of H₂O₂ is as intended. It is to be understood that within a stage of separation, whether that separation be of distillation or of membrane technology or a combination thereof, that improved separation can be accomplished with multiple stages of separation as compared to a single stage.

It is preferred that said electrolysis in the first stage be performed with at least one of a conductive organic membrane and a conductive inorganic membrane. It is most preferred that said organic and/or said inorganic membrane be conductive as is known in the art. It is preferred to perform electrolysis in the first stage and that the separation of H₂ from H₂S₂O₈ and unreacted H₂SO₄ is performed by at least one of membrane separation and distillation. It is a preferred embodiment to perform electrolysis with an electrode in the first stage. It is preferred that said electrode be made of a corrosion resistant material. It is preferred that said electrode material be made at lest one of: zirconium, hastelloy, titanium, ceramic and any combination thereof. It is most preferred that the separation of H₂ from H₂S₂O₈ and unreacted H₂SO₄ be performed with a membrane. It is preferred that the separation of H₂ from H₂S₂O₈ and unreacted H₂SO₄ be performed with distillation. It is preferred that the separation of H₂S₂O₈ from unreacted H₂SO₄ be performed with at lest one of distillation and membrane separation. It is preferred that the separation of H₂ from H₂S₂O₈ and unreacted H₂SO₄ be performed with at least one of distillation and membrane separation.

It is most preferred that, in the second stage, the separation of at least one of H₂O₂ and unreacted H₂O from at least one of H₂SO₄ and unreacted H₂S₂O₈ be performed with a membrane. It is most preferred that the separation of H₂SO₄ from unreacted H₂S₂O₈ in the second stage be performed with a membrane. It is an embodiment that the separation of at least one of H₂O₂ and unreacted H₂O in the second stage from at least one of H₂SO₄ and unreacted H₂S₂O₈ be performed with distillation. It is an embodiment that the separation of H₂SO₄ from H₂S₂O₈ in the second stage be performed with distillation. It is most preferred that the second stage be separated into two portions, wherein at lest one of H₂O₂ and H₂O are separated from at least one of H₂SO₄ and unreacted H₂S₂O₈ in the first portion and H₂SO₄ is separated from unreacted H₂S₂O₈ in the second portion. It is most preferred that said separated H₂SO₄ in the second stage flow to the first stage.

It is most preferred that an excess amount of H₂O be added to the second stage so that the produced H₂O₂ is dilute upon formation to a concentration which maximizes safety in a given end-use application. It is preferred that the H₂O₂ in the second stage be diluted with H₂O upon separation of said H₂O₂ from at lest one of H₂SO₄ and/or H₂S₂O₈ to a concentration which maximizes safety in a given end-use application.

Physical Properties

Water, H₂O, is clear with no color having a freezing point of 0° C. and a boiling point of 100° C.

H₂SO₄ has a freezing point of 10° C. and a boiling point of 338° C.

H₂O₂ has a freezing point of 0° C. and a boiling point of 150° C.

While H₂ is a colorless gas at ambient conditions, H₂S₂O₈ is a yellowish to brown solid below 65° C. and decomposes above its melting point; however, H₂SO₄ is a good solvent for H₂S₂O₈. In the instant invention it is preferred that stage 1, the transfer line from stage 1 to stage 2 and stage 2 be insulated having a temperature control loop to maintain operating temperatures. It is preferred that the operating temperature of stage 1 and the transfer line from stage 1 to the H₂S₂O₈/H₂O reaction chamber be approximately between 20 and 70° C., and most preferably between 50 and 65° C. Further, it is preferred that the electrolysis in stage 1 not carry to completion so that residual H₂SO₄ can be used as a solvent for H₂S₂O₈ transferred to Stage 2. Recycle of H₂O from stage 2 to stage 1 in the H₂SO₄ recycle line will result in the electrolysis of H₂O in stage 1, thereby reducing system efficiency while creating O₂ in the system or sending O₂ to the H₂ side of the fuel cell. In light of this operating possibility, in the instant invention it is preferred that stage 2 have an operating temperature of between 100 to 170° C. and most preferably between 105 to 115° C., along with an O₂ purge in the H₂S₂O₈/H₂SO₄ line from stage 1 to stage 2. It is preferred to send the O₂ purge to the air (oxidizer) side of the fuel cell.

Said temperature control loops can be any heating/cooling loop as is known in the art. It is preferred to heat stage 1 and/or stage 2 with an electrical resistant circuit and to cool stage 1 and/or stage 2 with a H₂O jacket. It is most preferred to use the heat of electrolysis to heat stage 1 and the heat of reaction of H₂O with H₂S₂O₈ to maintain operating temperature in stage 2 and/or stage 1. It is an embodiment to heat stage 1 and/or stage 2 with a steam jacket. It is most preferred to manage the temperature in stage 2 by the temperature of the water/steam added to the reaction chamber for the H₂S₂O₈/H₂O reaction to H₂O₂. Stage 1 operating temperature is most preferably maintained by the cooling of H₂SO₄ from stage 2 to stage 1. Said cooling of H₂SO₄ is most preferably accomplished with ambient convective heat transfer. Cooling of H₂SO₄ from stage 2 to stage 1 is preferably accomplished with a water jacket on the H₂SO₄ transfer line from stage 2 to stage 1. Once operating temperatures are obtained, cooling will often be required to remove the heat energy of electrolysis generated in stage 1.

It is preferred that the production of H₂O₂ by this instant invention be performed at the end-use location to minimize or eliminate at least one of storage and/or vehicular transportation of H₂O₂. It is most preferred to utilize H₂O₂ manufactured by this instant invention in the manufacture of electric circuit devices. It is most preferred to utilize H₂O₂ manufactured by this instant invention in the purification of water.

### EXAMPLE 1

Concentrated sulfuric acid is placed in a flask having three openings, one on each side and one in the middle. Inside one side opening is placed a rod of titanium; this opening is sealed with a rubber stopper. The sulfuric acid solution is heated to 50° C., as measured by a thermometer in the middle opening sealed with a rubber stopper. Inside the other side opening is placed a rod of titanium; this opening is left open. A 12 volt dc car battery is connected to the electrodes, with the cathode at the open port and the anode at the closed port. Within about a minute the concentrated sulfuric acid solution begins to turn yellow. The open port of the flask is lit with a match. The open port obviously contains hydrogen. Reaction is carried out until a full yellowish color is obtained in the flask. The electrodes are removed.

### EXAMPLE 2

The resultant solution from Example 1 is then slowly reacted with water until the solution becomes clear again. Once clear, the solution is heated to boiling, which occurs at about 100° C. and increases in intensity at about 150° C. The distilled vapors are obviously a combination of water and hydrogen peroxide. The remaining liquid has a pH of less than 1.0, being sulfuric acid.

### EXAMPLE 3

Example 2 is repeated. This time two flask openings are sealed, each sealed with a glass stopper. A Teflon tube is placed with one end on the third flask opening and the other end of the hose in a beaker of water. The flask is heated to 155° C. and boiled until boiling stops. The resultant distillate/water mixture is then poured on a pair of old leather shoes. An exothermic reaction takes place wherein, the shoes begin to smoke. The exothermic reaction on leather proves the resultant aqueous solution to contain hydrogen peroxide.

Certain objects are set forth above and made apparent from the foregoing description, tables, drawings and examples. However, since certain changes may be made in the above description, tables, drawings and examples without departing from the scope of the invention, it is intended that all matters contained in the foregoing description, tables, drawings and examples shall be interpreted as illustrative only of the principles of the invention and not in a limiting sense. With respect to the above description, tables, drawings and examples then, it is to be realized that any descriptions, tables, drawings and examples deemed readily apparent and obvious to one skilled in the art and all equivalent relationships to those stated in the tables, drawing and examples and described in the specification are intended to be encompassed by the present invention.

Further, since numerous modifications and changes will readily occur to those skilled in the art, it is not desired to limit the invention to the exact construction and operation shown and described, and accordingly, all suitable modifications and equivalents may be resorted to, falling within the scope of the invention. It is also to be understood that the following claims are intended to cover all of the generic and specific features of the invention herein described, and all statements of the scope of the invention which, as a matter of language, might be said to fall in between.

I claim:

1. A method for the preparation of H₂O₂ wherein,
H₂O₂ is produced by a first reaction, electrolysis converting H₂SO₄ into H₂ and H₂S₂O₈ and then a second reaction, said H₂S₂O₈ formed in first reaction, is reacted with H₂O in a second reaction to form H₂O₂ and H₂SO₄ and wherein,
at least one of: the separation of said H₂ from said H₂S₂O₈, the separation of said H₂ from a mixture of said H₂S₂O₈ and said H₂SO₄, the separation of said H₂O₂ from said H₂SO₄, the separation of said H₂O₂ from said H₂S₂O₈, the separation of said H₂O₂ and water from said H₂SO₄, the separation of said H₂O₂ from a mixture of said H₂SO₄ and said H₂S₂O₈, the separation of said H₂SO₄ from said H₂S₂O₈ and any combination therein is performed with a membrane.

2. The method of claim 1, wherein the first reaction does not go to completion and wherein,
a mixture of H₂SO₄ and H₂S₂O₈ is reacted with H₂O in the second reaction.

3. The method of claim 1, wherein said membrane is constructed of organic materials.

4. The method of claim 1, wherein said membrane is constructed of inorganic materials.

5. The method of claim 1, wherein said H₂SO₄ in the second reaction is recycled to the first reaction.

6. The method of claim 1, wherein said electrolysis is performed across an electrically charged conductive membrane.

7. The method of claim 1, wherein said electrolysis is performed with electrodes.

8. The method of claim 7, wherein said electrodes are made of at least one of: zirconium, hastelloy, ceramic and titanium.

9. The method of claim 1, wherein at least one of the separation processes is performed with distillation.

10. The method of claim 9, wherein said distillation separates H₂ from at least one of H₂SO₄ and H₂S₂O₈.

11. The method of claim 9, wherein said distillation separates H₂O₂ from at least one of H₂SO₄ and H₂S₂O₈.

12. The method of claim 9, wherein said distillation separates H₂O from at least one of H₂SO₄ and H₂S₂O₈.

13. The method of claim 1, wherein said second reaction contains an excess of said H₂O, wherein an aqueous concentration of said H₂O₂ is generated.

14. The method of claim 1, wherein H₂O is added to said H₂O₂ from said second reaction.

15. The method of claim 1, wherein there is no vehicular transportation of said H₂O₂.

16. The method of claim 1, wherein said H₂ produced in the first reaction is utilized in a fuel cell to generate electricity.

17. The method of claim 16, wherein at least a portion of said electricity is used for the electrolytic conversion of H₂SO₄ into H₂ and H₂S₂O₈.

18. A process of H₂O₂ production wherein,
H₂O₂ is produced by a first reaction, electrolysis converting H₂SO₄ into H₂ and H₂S₂O₈ and then a second reaction, said H₂S₂O₈ formed in first reaction, is reacted with H₂O in a second reaction to form H₂O₂ and H₂SO₄ and wherein,
at least one of: the separation of said H₂ from said H₂S₂O₈, the separation of said H₂ from a mixture of said H₂S₂O₈ and said H₂SO₄, the separation of said H₂O₂ from said H₂SO₄, the separation of said H₂O₂ from said H₂S₂O₈, the separation of said H₂O₂ and water from said H₂SO₄, the separation of said H₂O₂ from a mixture of said H₂SO₄ and said H₂S₂O₈, the separation of said H₂SO₄ from said H₂S₂O₈ and any combination therein is performed with a membrane.

19. The process of claim 18, wherein the first reaction does not go to completion and wherein,
a mixture of H₂SO₄ and H₂S₂O₈ is reacted with H₂O in the second reaction.

20. The process of claim 18, wherein said membrane is constructed of organic materials.

21. The process of claim 18, wherein said membrane is constructed of inorganic materials.

22. The process of claim 18, wherein said H₂SO₄ in the second reaction is recycled to the first reaction.

23. The process of claim 18, wherein said electrolysis is performed across an electrically charged conductive membrane.

24. The process of claim 18, wherein said electrolysis is performed with electrodes.

25. The process of claim 24, wherein said electrodes are made of at least one of: zirconium, hastelloy, ceramic and titanium.

26. The process of claim 18, wherein at least one of the separation processes is performed with distillation.

27. The process of claim 26, wherein said distillation separates H₂ from at least one of H₂SO₄ and H₂S₂O₈.

28. The process of claim 26, wherein said distillation separates H₂O₂ from at least one of H₂SO₄ and H₂S₂O₈.

29. The process of claim 26, wherein said distillation separates H₂O from at least one of H₂SO₄ and H₂S₂O₈.

30. The method of claim 18, wherein said second reaction contains an excess of said H₂O, wherein an aqueous concentration of said H₂O₂ is generated.

31. The process of claim 18, wherein H₂O is added to said H₂O₂ from said second reaction.

32. The process of claim 18, wherein there is no vehicular transportation of said H₂O₂.

33. The process of claim 18, wherein said H₂ produced in the first reaction is utilized in a fuel cell to generate electricity.

34. The process of claim 33, wherein at least a portion of said electricity is used for the electrolytic conversion of H₂SO₄ into H₂ and H₂S₂O₈.
